(19) United States
(12) Patent Application Publication
(10) Pub. No.: US 2016/0228950 A1
(43) Pub. Date: Aug. 11, 2016

(54) METHODS FOR RELIEVING STRESS IN AN ADDITIVELY MANUFACTURED ALLOY BODY

(71) Applicant: ALCOA INC., Pittsburgh, PA (US)

(72) Inventors: Brandon H. Bodily, Broadview Heights, OH (US); Dustin M. Bush, Avon Lake, OH (US)

(21) Appl. No.: 15/005,825

(22) Filed: Jan. 25, 2016

Related U.S. Application Data
(60) Provisional application No. 62/112,291, filed on Feb. 5, 2015.

(51) Int. Cl. B22F 3/24; C22C 21/04; C22F 1/043; B22F 3/105

(52) U.S. Cl. CPC B22F 3/24; B22F 3/1055; C22C 21/04; C22F 1/043; B33Y 10/00

(57) ABSTRACT

Methods for producing additively manufactured products are disclosed. In one embodiment, a method comprises using additive manufacturing to produce an aluminum alloy body, and, after the using step (a), cold working at least a portion of the aluminum alloy body, thereby relieving stress.

### CROSS-REFERENCE TO RELATED APPLICATION

This patent application claims benefit of priority of United States Provisional Patent Application No. 62/112,291, filed Feb. 5, 2015, entitled “METHODS FOR RELIEVING STRESS IN AN ADDITIVELY MANUFACTURED ALLOY BODY”, which is incorporated herein by reference in its entirety.

### BACKGROUND

Aluminum alloy products may be produced via either shape casting or wrought processes. Shape casting generally involves casting a molten aluminum alloy into its final form, such as via pressure-die, permanent mold, green- and dry-sand, investment, and plaster casting. Wrought products are generally produced by casting a molten aluminum alloy into ingot or billet. The ingot or billet is generally further hot worked, sometimes with cold work, to produce its final form.

### SUMMARY

Broadly, the present patent application relates to improved methods for relieving stress in an additively manufactured aluminum alloy body. In one embodiment, a method includes using additive manufacturing to produce an aluminum alloy body. The aluminum alloy body may realize a first amount of residual stress due to, at least in part, the additive manufacturing step. After the additive manufacturing, at least a portion of the additively manufactured aluminum alloy body may be cold worked, thereby relieving stress in cold worked portions of the aluminum alloy body. At least some of the cold worked portions of the aluminum alloy body may realize a second amount of residual stress due, at least in part, to the cold working step, wherein the second amount of residual stress is lower than the first amount of residual stress. Optionally, after the cold working, the aluminum alloy body may be thermally treated at temperatures of not greater than 450° F. (232.2° C.) to potentially further stress relieve and/or strengthen the aluminum alloy body.

As used herein, “additive manufacturing” means “a process of joining materials to make objects from 3D model data, usually layer upon layer, as opposed to subtractive manufacturing methodologies”, as defined in ASTM F2792-12a entitled “Standard Terminology for Additively Manufacturing Technologies”. In some embodiments, additive manufacturing may include powder bed technology such as Selective Laser Sintering (SLS), Selective Laser Melting (SLM), and Electron Beam Melting (EBM), among others. Additive manufacturing may also include wire extrusion technologies such as Fused Filament Fabrication (FFF), among others. Suitable additive manufacturing systems include the EOSINT M 280 Direct Metal Laser Sintering (DMLS) additive manufacturing system, available from EOS GmbH (Robert-Stirling-Ring 1, 82152 Krailling/Munich, Germany).

As discussed above, additive manufacturing may be used to produce an aluminum alloy body. An aluminum alloy body is a body comprising aluminum and at least one other substance, wherein the aluminum comprises at least 50 wt. % of the body. Examples of aluminum alloys that may be in additively manufactured include the lxxx, 2xxx, 3xxx, 4xxx, 5xxx, 6xxx, 7xxx, and 8xxx aluminum series alloys, as defined by The Aluminum Association. In one embodiment, the aluminum alloy is a lxxx series aluminum alloy. In one embodiment, the aluminum alloy is a 2xxx series aluminum alloy. In one embodiment, the aluminum alloy is a 3xxx series aluminum alloy. In one embodiment, the aluminum alloy is a 4xxx series aluminum alloy. In one embodiment, the aluminum alloy is a 5xxx series aluminum alloy. In one embodiment, the aluminum alloy is a 6xxx series aluminum alloy. In one embodiment, the aluminum alloy is a 7xxx series aluminum alloy. In one embodiment, the aluminum alloy is a 8xxx series aluminum alloy. Casting alloys, such as any of the 1xx-8xx series casting alloys may also be used.

In one embodiment, the aluminum alloy is a 4046 style aluminum alloy, as defined by the Aluminum Association, having: 9.0-11.0 wt. % Si; 0.2-0.45 wt. % Mg; up to 0.55 wt. % Fe; up to 0.45 wt. % Mn; up to 0.15 wt. % Ti; up to 0.1 wt. % Zn; up to 0.05 wt. % Cu; up to 0.05 wt. % Ni; up to 0.05 wt. % Pb; up to 0.05 wt. % Sn; and the balance being aluminum and other elements, wherein the aluminum alloy includes no more than 0.05 wt. % of any one of the other elements, and with the total of the other elements not exceeding 0.15 wt. %.

In one aspect, residual stress may be imparted to the aluminum alloy body, for example, via the additive manufacturing process. As used herein, “residual stress” is the stress present in an aluminum alloy body in the absence of external load on the aluminum alloy body. Residual stress of an aluminum alloy body may be measured via the “Slitting Method”, as described in “Experimental Procedure for Crack Compliance (Slitting) Measurements of Residual Stress,” by M. B. Prime, LA-UR-03-8629, Los Alamos National Laboratory Report, 2003 procedure. Residual stress may be measured in units of 1,000 pounds per square inch (ksi). Residual stress may comprise compressive residual stress and/or tensile residual stress. Compressive residual stress may be expressed as a negative value, e.g., −15 ksi. Tensile stress may be expressed as a positive value, e.g, 10 ksi. Accordingly, a second amount of residual stress being “lower” than a first amount of residual stress means that the magnitude (i.e., absolute value) of the second amount of stress is smaller than the magnitude of the first amount of residual stress.

As discussed above, after the using step, at least a portion of the additively manufactured aluminum alloy body may be cold worked, thereby relieving stress in cold worked portions of the aluminum alloy body. As used herein, “cold working” and the like means plastically (i.e. permanently) deforming an aluminum alloy body in at least one direction and at temperatures below hot working temperatures (e.g., not greater than 250° F. (121.1° C.)). In one embodiment, cold working is initiated at ambient temperature. Cold working may be imparted by one or more of compressing, stretching, and combinations thereof, among other types of cold working methods. Compressing means pushing at least one surface of an aluminum alloy body in order to deform the aluminum alloy body by reducing at least one dimension of the aluminum alloy body. Compressing includes rolling, forging and combinations thereof. Stretching means pulling an aluminum alloy body in order to deform the alloy body by expanding at least one dimension of the aluminum alloy body.

In one embodiment, the cold working of the aluminum alloy body may be uniform (i.e., all parts of the aluminum alloy body may realize essentially the same amount of plastic deformation). In another embodiment, the cold working of the aluminum alloy body may be non-uniform (i.e., different parts of the aluminum alloy body may realize different amounts of plastic deformation). In one aspect, the cold working of the aluminum alloy body may comprise cold working all of the aluminum alloy body (e.g., all parts of the aluminum alloy body may realize at least some plastic deformation throughout the volume of the aluminum alloy body). In one embodiment, the cold working may comprise cold deforming all parts of the aluminum alloy body by at least 0.1%. In another embodiment, the cold working may comprise cold deforming all parts of the aluminum alloy body by at least 0.2%. In yet another embodiment, the cold working may comprise cold deforming all parts of the aluminum alloy body by at least 0.3%. In another embodiment, the cold working may comprise cold deforming all parts of the aluminum alloy body by at least 0.4%. In yet another embodiment, the cold working may comprise cold deforming all parts of the aluminum alloy body by at least 0.5%. In another embodiment, the cold working may comprise cold deforming all parts of the aluminum alloy body by at least 0.6%. In yet another embodiment, the cold working may comprise cold deforming all parts of the aluminum alloy body by at least 0.7%. In another embodiment, the cold working may comprise cold deforming all parts of the aluminum alloy body by at least 0.8%. In yet another embodiment, the cold working may comprise cold deforming all parts of the aluminum alloy body by at least 0.9%. In another embodiment, the cold working may comprise cold deforming all parts of the aluminum alloy body by at least 1.0%. In yet another embodiment, the cold working may comprise cold deforming all parts of the aluminum alloy body by at least 1.5%. In another embodiment, the cold working may comprise cold deforming all parts of the aluminum alloy body by at least 2.0%. In yet another embodiment, the cold working may comprise cold deforming all parts of the aluminum alloy body by at least 3.0%. In another embodiment, the cold working may comprise cold deforming all parts of the aluminum alloy body by at least 4.0%. In yet another embodiment, the cold working may comprise cold deforming all parts of the aluminum alloy body by at least 5.0%.

In another aspect, the cold working of the aluminum alloy body may comprise cold working only a portion of the aluminum alloy body (i.e., some parts of the aluminum alloy body may realize at least some plastic deformation, while other parts of the aluminum alloy body may realize no plastic deformation). In one embodiment, the cold working comprises cold deforming only a portion of the aluminum alloy body by at least 0.1%. In another embodiment, the cold working comprises cold deforming only a portion of the aluminum alloy body by at least 0.2%. In yet another embodiment, the cold working comprises cold deforming only a portion of the aluminum alloy body by at least 0.3%. In another embodiment, the cold working comprises cold deforming only a portion of the aluminum alloy body by at least 0.4%. In yet another embodiment, the cold working comprises cold deforming only a portion of the aluminum alloy body by at least 0.5%. In another embodiment, the cold working comprises cold deforming only a portion of the aluminum alloy body by at least 0.6%. In yet another embodiment, the cold working comprises cold deforming only a portion of the aluminum alloy body by at least 0.7%. In another embodiment, the cold working comprises cold deforming only a portion of the aluminum alloy body by at least 0.8%. In yet another embodiment, the cold working comprises cold deforming only a portion of the aluminum alloy body by at least 0.9%. In another embodiment, the cold working comprises cold deforming only a portion of the aluminum alloy body by at least 1.0%. In yet another embodiment, the cold working comprises cold deforming only a portion of the aluminum alloy body by at least 1.5%. In another embodiment, the cold working comprises cold deforming only a portion of the aluminum alloy body by at least 2.0%. In yet another embodiment, the cold working comprises cold deforming only a portion of the aluminum alloy body by at least 3.0%. In another embodiment, the cold working comprises cold deforming only a portion of the aluminum alloy body by at least 4.0%. In yet another embodiment, the cold working comprises cold deforming only a portion of the aluminum alloy body by at least 5.0%.

In one embodiment, during the cold working step, the temperature of the aluminum alloy body is not greater than 250° F. (121.1° C.). In another embodiment, during the cold working step, the temperature of the aluminum alloy body is not greater than 225° F. (107.2° C.). In yet another embodiment, during the cold working step, the temperature of the aluminum alloy body is not greater than 200° F. (93.3° C.). In another embodiment, during the cold working step, the temperature of the aluminum alloy body is not greater than 175° F. (79.4° C.). In yet another embodiment, during the cold working step, the temperature of the aluminum alloy body is not greater than 150° F. (65.6° C.). In yet another embodiment, during the cold working step, the temperature of the aluminum alloy body is not greater than 125° F. (51.7° C.). In yet another embodiment, during the cold working step, the temperature of the aluminum alloy body is not greater than 100° F. (37.8° C.). In one embodiment, the cold working step is initiated when the aluminum alloy body is at ambient temperature.

In one embodiment, the cold working may occur only after the using additive manufacturing step is complete (e.g., only the final version of the additively manufactured alloy body is cold worked). Thus, prior to the cold working step, the method may be free of any other cold working steps. In one embodiment, the cold working step comprises cold deforming the aluminum alloy body by not greater than 25%. In another embodiment, the cold working step comprises cold deforming the aluminum alloy body by not greater than 20%. In yet another embodiment, the cold working step comprises cold deforming the aluminum alloy body by not greater than 15%. In another embodiment, the cold working step comprises cold deforming the aluminum alloy body by not greater than 14%. In yet another embodiment, the cold working step comprises cold deforming the aluminum alloy body by not greater than 13%. In another embodiment, the cold working step comprises cold deforming the aluminum alloy body by not greater than 12%. In yet another embodiment, the cold working step comprises cold deforming the aluminum alloy body by not greater than 11%. In another embodiment, the cold working step comprises cold deforming the aluminum alloy body by not greater than 10%.

In one aspect, relieving residual stress in the additively manufactured aluminum alloy body via the above-described methods may provide improved strength properties as compared to relieving residual stress via annealing the aluminum alloy body. For example, the aluminum alloy body may realize increased tensile yield strength as compared to a similar aluminum alloy body which has been annealed to relieve stress. Thus, in one embodiment, the method of production is free of any anneal and/or solution heat treatment step between the using additive manufacturing step and the cold working step. Thus, during production of the aluminum alloy body, after the additively manufacturing step, the aluminum alloy body may be maintained at a temperature of not greater than 450°. In other embodiments, during production of the aluminum alloy body, after the additive manufacturing step, the aluminum alloy body is maintained at a temperature of not greater than 400° F., such as not greater than 375° F., or not greater than 350° F., or not greater than 325° F., or not greater than 300° F., or not greater than 275° F., or not greater than 250° F., or not greater than 225° F., or not greater than 200° F., or not greater than 175° F., or not greater than 150° F., or not greater than 125° F., or not greater than 100° F., or not greater than ambient (not including any heat generated due to the cold working step). In one embodiment, the aluminum alloy body may undergo a solution heat treatment step after the additive manufacturing step and before the cold working step.

In other embodiments, after the cold working step, the aluminum alloy body may be thermally treated. The thermal treatment may further stress relieve and/or strengthen one or more portions of the aluminum alloy body. For instance, for precipitation hardenable alloys, the thermal treatment may result in precipitation hardening of one or more portions of the aluminum alloy body. The thermal treatment may also or alternatively stress relieve the aluminum alloy body. This optional thermal treatment step may occur at a temperature of from, for example, 175° F. (79.4° C.) to 450° F. (232.2° C.) and from several minutes to several hours, depending on temperature.

While various embodiments of the present disclosure have been described in detail, it is apparent that modification and adaptations of those embodiments will occur to those skilled in the art. However, it is to be expressly understood that such modifications and adaptations are within the spirit and scope of the present disclosure.

What is claimed is:

1. A method comprising:
(a) using additive manufacturing to produce an aluminum alloy body;
wherein, due at least in part to the using additive manufacturing step (a), the aluminum alloy body realizes a first amount of residual stress;
(b) after the using step (a), cold working at least a portion of the aluminum alloy body, thereby relieving stress in cold worked portions of the aluminum alloy body;
wherein the cold working comprises cold deforming the aluminum alloy body by at least 0.1%;
wherein, due at least in part to the cold working step (b), at least some of the cold worked portions realize a second amount of residual stress; and
wherein the second amount of residual stress is lower than the first amount of residual stress.

2. The method of claim 1, wherein the aluminum alloy body is an aluminum alloy selected from the group consisting of: a 1xxx aluminum alloy, a 2xxx aluminum alloy, a 3xxx aluminum alloy, a 4xxx aluminum alloy, a 5xxx aluminum alloy, a 6xxx aluminum alloy, a 7xxx aluminum alloy, and an 8xxx aluminum alloy.

3. The method of claim 1, wherein the aluminum alloy body is a 4xxx series aluminum alloy.

4. The method of claim 3, wherein the aluminum alloy body is a 4046 aluminum alloy.

5. The method of claim 1, wherein the cold working step (b) comprises at least one of compressing, stretching, and combinations thereof.

6. The method of claim 1, wherein the cold working step (b) comprises cold deforming all parts of the aluminum alloy body by at least 0.1%.

7. The method of claim 1, wherein the cold working step (b) comprises cold deforming by not greater than 25%.

8. The method of claim 7, wherein during the cold working step, the aluminum alloy body is at a temperature of not greater than 250° F.

9. The method of claim 1, wherein, due at least in part to the cold working step (b), the aluminum alloy body realizes increased tensile yield strength as compared to a similar aluminum alloy body which has been annealed to relieve residual stress.

10. The method of claim 1, comprising:
performing the using additive manufacturing step (a) and then performing the cold working step (b), wherein the method is free of any solution heat treatment step between steps (a) and (b).

11. The method of claim 10, wherein the method is free of any solution heat treating step after step (b).

12. The method of any claim 10, wherein, after the using step, aluminum alloy body is maintained below 450° F.

13. The method of claim 1, comprising:
artificially aging the aluminum alloy body at a temperature of from 150° F. to 450° F.

14. A method consisting of:
(a) using additive manufacturing to produce an aluminum alloy body;
wherein, due at least in part to the using additive manufacturing step (a), the aluminum alloy body realizes a first amount of residual stress;
(b) after the using step (a), cold working the aluminum alloy body, thereby relieving stress in the aluminum alloy body;
wherein the cold working comprises cold deforming the aluminum alloy body by at least 0.1%;
wherein due at least in part to the cold working step (b), the aluminum alloy body realizes a second amount of residual stress; and
wherein the second amount of residual stress is lower than the first amount of residual stress.
